(19) United States
(12) Patent Application Publication
(10) Pub. No.: US 2023/0263590 A1
(43) Pub. Date: Aug. 24, 2023

(54) Ultrasonic liquid-to-gas device with dynamic balance

(71) Applicant: Lahui TANG, Foshan (CN)

(72) Inventor: Lahui TANG, Foshan (CN)

(21) Appl. No.: 18/093,335

(22) Filed: Jan. 5, 2023

(30) Foreign Application Priority Data
Feb. 21, 2022 (CN) 202210156826.1

(51) Int. Cl. A61C 1/00

(52) U.S. Cl. CPC A61C 1/0015; A61C 1/0092

(57) ABSTRACT

An ultrasonic liquid-to-gas device with dynamic balance, including an ultrasonic mixing tower, a liquid supplying mechanism and a dynamic self-balancing mechanism. The ultrasonic mixing tower is provided with an air input port and a mixed gas output port, and is formed by a plurality of tower body components connected together; each tower body component is built-in with an ultrasonic hybrid cutting filter screen mechanism. An ultrasonic liquid atomizing mechanism that atomizes liquid is also provided inside the ultrasonic mixing tower adjacent to the air input port; the liquid supplying mechanism is connected with the ultrasonic liquid atomizing mechanism through a pipeline; a middle position of the dynamic self-balancing mechanism is tiltably connected to a bottom of the ultrasonic mixing tower, and four lateral sides of the dynamic self-balancing mechanism are also tiltably connected to lateral sides of the ultrasonic mixing tower respectively.

### FIELD OF THE INVENTION

This invention relates to the technical field of liquid atomization or gasification treatment device and specifically relates to a treatment device which atomizes liquid into gaseous state by ultrasound.

### BACKGROUND OF THE INVENTION

A patent document (Chinese patent application number: 201811268975.7; publication number: CN109569390A) entitled “An Ultrasonic Oil Fuel Gasification Device” discloses a gasification device that converts oil fuel into gaseous state. The device comprises a casing with an inner chamber, filter screen components or filter cylinders, ultrasonic transducers, an ultrasonic generator, and a fuel injection and air input module. The casing is provided with an input port and an output port in communication with each other, and the fuel injection and air input module is provided on the input port. The filter components or the filter cylinders have mesh sizes of 0.1 mm-10 mm and are provided in the inner chamber. The ultrasonic transducers are provided in the casing and are connected with the filter screen components or filter cylinders, to drive the filter screen components or filter cylinders to vibrate in ultrasound of high-frequency. Ultrasonic wave is used to generate high-frequency ultrasonic vibration to multiple layers of filter screen components or filter cylinders, so that the oil fuel and air injected into the inner chamber pass through in sequence every filter component or filter cylinder vibrating in high-frequency ultrasound. As such, the mixture of oil fuel and air is intercepted layer by layer and is molecularized for thousands of times, so that the injected liquid oil fuel is crushed to atomized form and fully and uniformly mixed with the air. The required combustion gas mixture is finally output for use.

Said technical solution utilizes high-frequency ultrasound for molecularization to atomize the oil fuel and fully mix the oil fuel with air to obtain the required gas mixture, yet limitations still exist: Firstly, due to its structural design, the volume and efficiency of atomization treatment are limited, and cannot be arbitrarily increased or decreased according to actual needs, and therefore the device cannot be manufactured or sold in a modularized manner. Secondly, as oil fuel is directly injected into the device to be mixed directly with the air, the size of liquid particles in the atomized oil fuel is relatively large and is difficult to be thoroughly and fully mixed with the air. Thirdly, the device does not comprise dynamic self-balancing function and therefore will not be dynamically self-balanced when the device is used in dynamic operating machines. Thus, the device cannot be applied to dynamic operating machines, which affects its range of application. The deficiencies of the said technical solution cannot well meet the needs of production activities.

### BRIEF SUMMARY OF THE INVENTION

To solve the above technical problem, this invention provides an ultrasonic liquid-to-gas device with dynamic balance, comprising components such as an ultrasonic mixing tower, an ultrasonic liquid atomizing mechanism and a dynamic self-balancing mechanism, such that this invention may be assembled flexibly in various ways according to actual needs to meet the needs of applications in different circumstances. The modularized and standardized design helps reduce the design and production costs; besides, after being atomized by the built-in ultrasonic liquid atomizing mechanism and then being sufficiently mixed with air, the mixed gas produced is well mixed so that it can be fully utilized during use, and the produced mixed gas may also be applied to dynamic operating machines.

The technical solution of this invention is as follows: an ultrasonic liquid-to-gas device with dynamic balance, comprising: an ultrasonic mixing tower, wherein the ultrasonic mixing tower is provided with an air input port and a mixed gas output port, and is formed by a plurality of tower body components connected together, each of the tower body components is built-in with an ultrasonic hybrid cutting filter screen mechanism; an ultrasonic liquid atomizing mechanism is also provided inside the ultrasonic mixing tower adjacent to the air input port; the ultrasonic liquid atomizing mechanism atomizes liquid; atomized liquid generated by the ultrasonic liquid atomizing mechanism is mixed with air input from the air input port; a liquid supplying mechanism is also provided in the ultrasonic liquid-to-gas device, wherein the liquid supplying mechanism is connected with the ultrasonic liquid atomizing mechanism through a pipeline to pump liquid to the ultrasonic liquid atomizing mechanism; a dynamic self-balancing mechanism is also provided in the ultrasonic liquid-to-gas device, wherein a middle position of the dynamic self-balancing mechanism is tiltably connected to a bottom of the ultrasonic mixing tower, and four lateral sides of the dynamic self-balancing mechanism are also tiltably connected to lateral sides of the ultrasonic mixing tower respectively; the ultrasonic mixing tower is balanced through the dynamic self-balancing mechanism.

Further, the dynamic self-balancing mechanism comprises a base mounting seat, universal joints, an electric gyroscope and a plurality of modifying and regulating motors; the base mounting seat is connected with the bottom of the ultrasonic mixing tower through one of the universal joints; the modifying and regulating motors are connected with lateral sides of an upper surface of the base mounting seat respectively, and are also connected with the lateral sides of the ultrasonic mixing tower respectively through other corresponding universal joints respectively; the electric gyroscope is installed in the ultrasonic mixing tower.

Further, the ultrasonic liquid atomizing mechanism comprises a conical atomizing disk and an ultrasonic atomizer module; the conical atomizing disk is provided at a position in the ultrasonic mixing tower facing the air input port, and the ultrasonic atomizer module is installed at a bottom of the conical atomizing disk; a plurality of air spray nozzles are distributed on an annular surface of the conical atomizing disk, and each air spray nozzle is in communication with the air input port.

The benefits of this invention: This invention comprises components such as the ultrasonic mixing tower, the ultrasonic liquid atomizing mechanism and the dynamic self-balancing mechanism, such that this invention is technically advantageous in that: Firstly, the design of the ultrasonic mixing tower is modularized and standardized; hence, this invention may be assembled flexibly in various ways according to actual needs so that the specifications required for the specified needs can be met, thereby satisfying the demand for different uses in different circumstances. Modularized and standardized design of the device reduces the design and production costs while promotes the competitiveness and the application of the device. Secondly, atomization of liquid according to this invention involves atomizing the liquid by the built-in ultrasonic liquid atomizing mechanism in the ultrasonic mixing tower, mixing the atomized liquid with air in the ultrasonic mixing tower where the mixture is intercepted and molecularized by high frequency ultrasound by the ultrasonic hybrid cutting filter screen mechanism arranged in multiple layers; after the mixed gas is well mixed, the final mixed gas is produced and output; accordingly, mixing is good, and the mixed gas obtained and be fully utilized during subsequent use, for example, being fully combusted, which reduces pollution and protects the environment. Thirdly, the dynamic self-balancing mechanism always holds the ultrasonic liquid atomizing mechanism in the ultrasonic mixing tower in an upright position, such that the liquid input into the ultrasonic liquid atomizing mechanism is always fully in contact with the ultrasonic atomizer and is always atomized efficiently. This also prevents the ultrasonic atomizer from burning due to weak contact with liquid. The technical solution of this invention may be used in oil fuel gasification devices.

### BRIEF DESCRIPTION OF THE DRAWINGS

FIG. 1 is a schematic view showing the structure of the present invention.

FIG. 2 is a side view of this invention.

FIG. 3 is a top view of this invention.

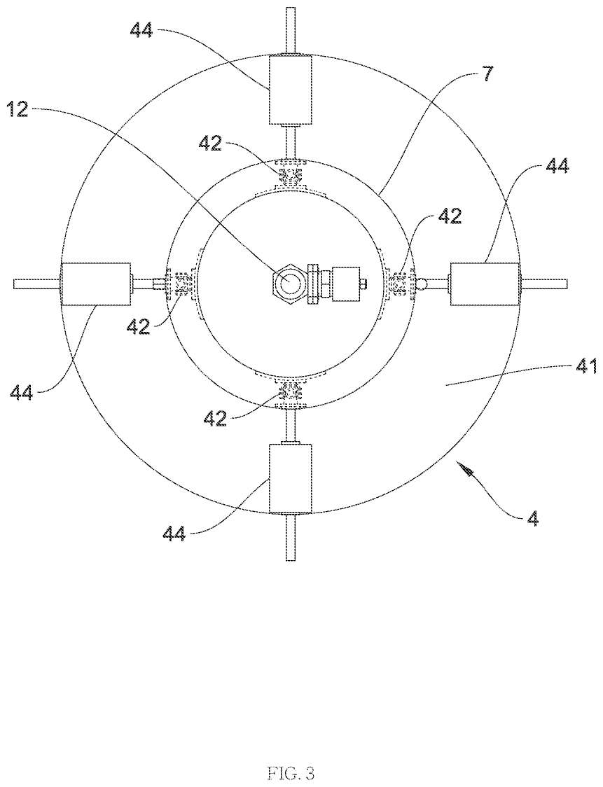

FIG. 4 is an exploded cross-sectional view of the ultrasonic mechanism in this invention.

### DETAILED DESCRIPTION OF THE INVENTION

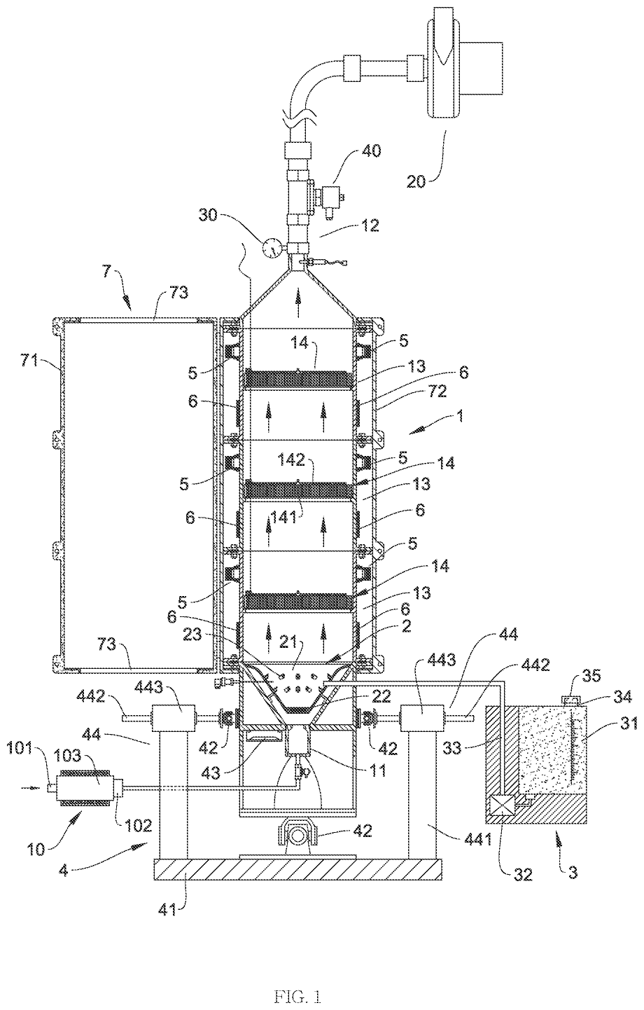

As shown in FIG. 1, an ultrasonic liquid-to-gas device with dynamic balance, comprising:

an ultrasonic mixing tower 1. The ultrasonic mixing tower 1 is provided with an air input port 11 and a mixed gas output port 12, and is formed by connecting a plurality of tower body components 13. Flanges and screws are used to assemble the plurality of tower body components 13 together, and a sealing ring is provided between every two adjacent flanges. A bottom part of the tower body component 13 located at the bottom of the ultrasonic mixing tower 1 is made into a cone shape, and the air input port 11 is provided at a bottom end of the tower body component 13 located at the bottom of the ultrasonic mixing tower 1. A top part of the tower body component 13 located at the top of the ultrasonic mixing tower 1 is made into a cone shape, and the mixed gas output port 12 is provided at a top end of such cone-shaped tower body component 13 at the top of the ultrasonic mixing tower 1.

A shown in FIG. 1, each of the tower body components 13 is built-in with an ultrasonic hybrid cutting filter screen mechanism 14. Each ultrasonic hybrid cutting filter screen mechanism 14 comprises a filter screen component 141 and an ultrasonic high-frequency vibration component 142 provided on the filter screen component 141. The ultrasonic high-frequency vibration component 142 may comprise an outer shell and a plurality of ultrasonic transducers or ultrasonic vibration motors distributed in the outer shell. Such design is to prevent the ultrasonic transducers or the ultrasonic vibration motors from being exposed and eroded by corrosive gas during application, so as to ensure its service life. Complete sealing and wrapping of the ultrasonic transducers or the ultrasonic vibration motors can also ensure the safety of the entire device operation by preventing the current during operation from generating sparks.

As shown in FIG. 1, an ultrasonic liquid atomizing mechanism 2 is also provided inside the ultrasonic mixing tower 1 adjacent to the air input port 11; the ultrasonic liquid atomizing mechanism 2 atomizes liquid. Mist generated by the ultrasonic liquid atomizing mechanism 2 is mixed with the air input from the air input port 11. The ultrasonic liquid atomizing mechanism 2 comprises a conical atomizing disk 21 and an ultrasonic atomizer module 22. The conical atomizing disk 21 is provided at a position in the ultrasonic mixing tower 1 facing the air input port 11, and the ultrasonic atomizer module 22 is installed at a bottom of the conical atomizing disk 21. A plurality of air spray nozzles 23 are distributed on an annular surface of the conical atomizing disk 21, and each air spray nozzle 23 is in communication with the air input port 11, so that the air input from the air input port 11 is dispersedly sprayed out through the air spray nozzles 23 and preliminarily mixed with the mist generated by the ultrasonic atomizer module 22. At the same time, the plurality of the air spray nozzles also facilitate movement of the mist generated by the ultrasonic atomizer 22 out from the conical atomizing disk 21, so that the mist moves upward inside the ultrasonic mixing tower 1 with a faster speed. The shape of the conical atomizing disc 21 not only facilitates the preliminary mixing of mist and air, but also facilitates receiving the droplets dropped from the ultrasonic hybrid cutting filter screen mechanism 14.

A liquid supplying mechanism 3. As shown in FIG. 1, the liquid supply mechanism 3 is connected with the ultrasonic liquid atomizing mechanism 2 through a pipeline to pump liquid to the ultrasonic liquid atomizing mechanism 2. As shown in FIG. 1, the liquid supply mechanism 3 comprises a liquid storage chamber 31, a liquid-supplying electric pump 32, a liquid output port 33 and a liquid-adding port 34; an openable sealing cover 35 is installed on the liquid-adding port 34. The liquid storage chamber 31 is used to store the liquid to be atomized, such as fuel oil. One end of the liquid-supplying electric pump 32 is connected with the liquid storage chamber 31, and another end is connected with the liquid output port 33. The liquid output port 33 is connected to the conical atomizing disc 21 of the ultrasonic liquid atomizing mechanism 2 through the pipeline. By controlling the liquid-supplying electric pump 32, a predetermined amount of liquid can be delivered to the conical atomizing disc 21 as required.

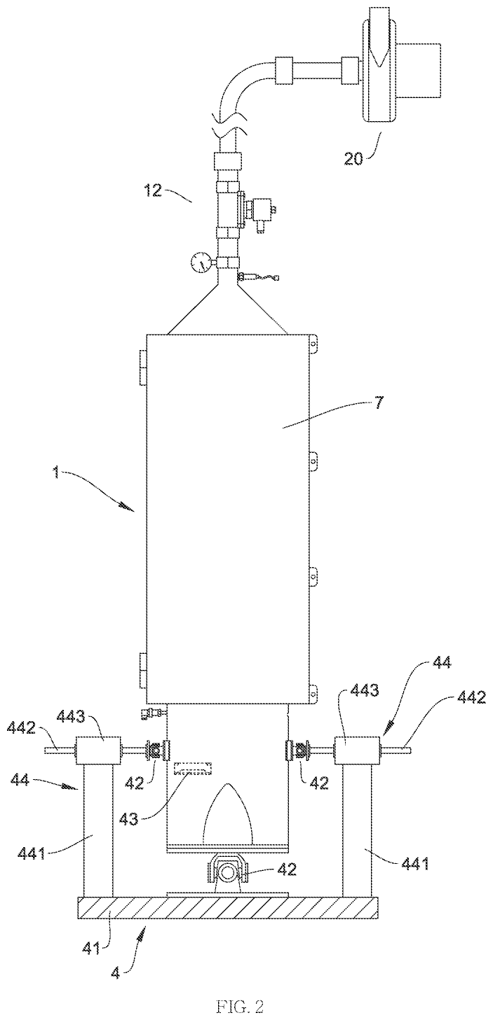

A dynamic self-balancing mechanism 4. As shown in FIGS. 1-2, a middle position of the dynamic self-balancing mechanism 4 is tiltably connected to the bottom of the ultrasonic mixing tower 1, and four lateral sides of the dynamic self-balancing mechanism 4 are also tiltably connected to lateral sides of the ultrasonic mixing tower 1 respectively; the ultrasonic mixing tower 1 is balanced through the dynamic self-balancing mechanism 4.

To achieve simple structure, low production cost, high reliability and easy realization of the dynamic self-balancing mechanism 4, as shown in FIG. 1, the dynamic self-balancing mechanism 4 comprises a base mounting seat 41, universal joints 42, an electric gyroscope 43 and a plurality of modifying and regulating motors 44; the base mounting seat 41 is connected with the bottom of the ultrasonic mixing tower 1 through one of the universal joints 42; the modifying and regulating motors 44 are connected with lateral sides of an upper surface of the base mounting seat 41, and the modifying and regulating motors 44 are connected with the lateral sides of the ultrasonic mixing tower 1 respectively through other corresponding universal joints 42 respectively; the electric gyroscope 43 is installed in the ultrasonic mixing tower 1. During operation, the electric gyroscope 43 detects a tilting direction of the ultrasonic mixing tower 1 and sends a corresponding signal of the detected tilting direction to a main control circuit board; according to such signal, the main control circuit board sends a command to the modifying and regulating motors 44 corresponding to the tilted direction to adjust the ultrasonic mixing tower 1 to a non-tilted balanced state.

As shown in FIG. 1, each of the modifying and regulating motors 44 in this embodiment comprises a vertical support 441, a horizontal push rod 442 and a motor 443. A bottom end of the vertical support 441 is connected to the base mounting seat 41; the motor 443 is installed on a top end of the vertical support 441; one end of the horizontal push rod 442 is connected to the motor 443, and another end of the horizontal push rod 442 is connected to a corresponding universal joint 42.

In order to prevent mixed gas of mist and air input to the tower body components 13 from adhering to inner walls of the tower body components and depositing during mixing process in the tower body components 13, as shown in FIG. 1, an ultrasonic mechanisms 5 are provided on an outer lateral wall of each of the tower body components 13. During gas treatment process in the tower body components 13, each of the ultrasonic mechanisms 5 vibrates in high frequency that acts on the corresponding tower body component 13 to effectively prevent the mixed gas from adhering to the inner walls and depositing, thereby keeping the inner walls of the tower body components 13 clean.

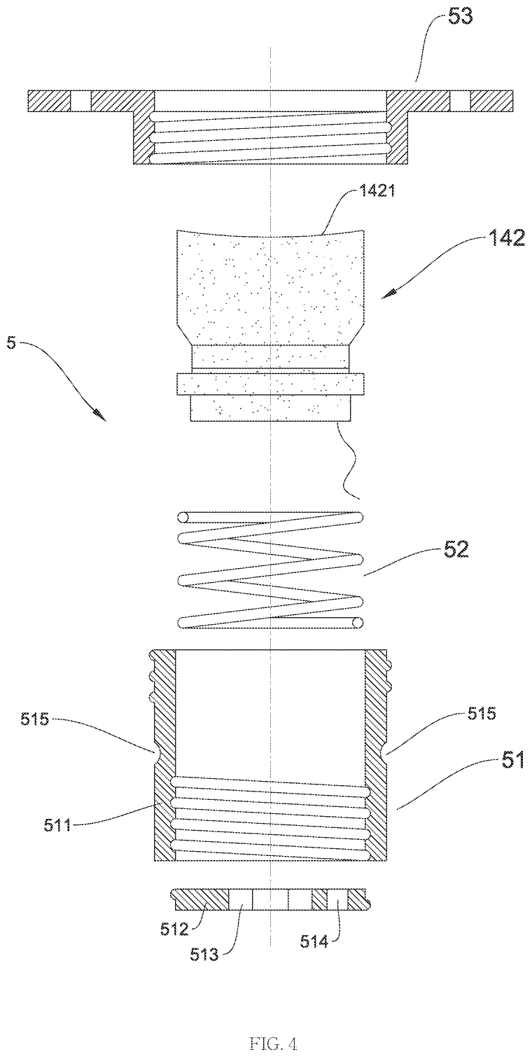

To achieve simple structure, convenient assembly and easy maintenance and replacement of the ultrasonic mechanisms 5, as shown in FIG. 4, each of the ultrasonic mechanisms 5 comprises an ultrasonic high-frequency vibrating component 142, a component casing 51, an elastic pressing component 52, and a connecting seat 53. The connecting seat 53 is installed on the outer lateral wall of the corresponding tower body component 13; one end of the elastic pressing component 52 is fixedly installed on an inner bottom surface of the component casing 51; the ultrasonic high-frequency vibration component 142 is fixedly installed on another end of elastic pressing component 52, so that the ultrasonic high-frequency vibration component 142 is placed in the component casing 51, and a vibrating end 1421 provided on a front end of the ultrasonic high-frequency vibration component 142 is exposed from the component casing 51. The component casing 51 and the connecting seat 53 are assembled together, and under the elastic action of the elastic pressing component 52, the vibrating end 1421 of the ultrasonic high-frequency vibrating component 142 is pressed on the outer lateral wall of the corresponding tower body assembly 13. Accordingly, the ultrasonic high-frequency vibration component 142 can be installed on the outer lateral wall of the corresponding tower body component 13 in a simple, efficient, convenient and firm and secured manner without welding and bonding, which is much safer; the ultrasonic high-frequency vibration component 142 can be simply removed from the corresponding tower body component 13 and replaced with a new one in case of malfunctions, so that maintenance is simpler and more convenient. In addition, the elastic pressing component 52 presses the ultrasonic high-frequency vibration component 142 to be in close contact with the outer lateral wall of the corresponding tower body component 13, which ensures the efficiency of conduction of ultrasonic energy from the front end of the ultrasonic high-frequency vibration component into the corresponding tower body component 13, as well as eliminating loss of ultrasonic energy and providing better shock absorption at the rear end of the ultrasonic high-frequency vibration component, so that the rear end of the ultrasonic high-frequency vibration component will not transmit resonance backwards, thus reducing shaking in general as well as resonance and noise, such that the use of ultrasonic wave improves the working and living environment.

During application, for easier adjustment of the elastic pressing force of the elastic pressing component 52 to ensure close contact of the ultrasonic high-frequency vibration component 142 with the outer lateral wall of the corresponding tower body component 13, as shown in FIG. 4, the component casing 51 comprises a cylindrical casing 511 and a bottom plate 512; an inner periphery of a bottom part of the cylindrical casing 511 is provided with internal threads while an outer periphery of the bottom plate 512 is provided with external threads threaded with the internal threads; the bottom plate 512 is threaded to the inner side of the bottom part of the cylindrical casing 511; the bottom plate 512 is further provided with a tool operation hole 513 and a wire hole 514. The bottom plate 512 can be rotated by inserting an operating tool, such as a screwdriver, into the tool operation hole 513, thereby adjusting the elastic pressing force exerted by the elastic pressing component 52 fixed on the bottom plate 512 against the ultrasonic high-frequency vibration component 142. The elastic pressing component 52 may be a spring, a metal elastic piece, an elastic rubber pad, a micro-hydraulic cylinder component, a pneumatic cylinder or other components which can exert elastic pressing force. Besides, an outer surface of the cylindrical casing 511 is further provided with a clamping position 515, so that the cylindrical casing 511 can be easily rotated and fixed on the connecting seat 53 by using a clamp.

To keep the inside of the tower body components dry, as shown in FIG. 1, the outer lateral wall of each of the tower body components 13 is also provided with an electric heating component 6 which surrounds and covers at least part of the outer lateral wall. Each electric heating component 6 heats and dries the inside of the corresponding tower body component 13 to prevent water vapor in the input gas from condensing on the inner walls of the tower body components affecting the quality of the generated mixed gas. Each electric heating component 6 comprises a casing and an electric heating film or electric heating wires disposed inside. Locking bolts and nuts are also provided at both ends of the casing respectively so that the casing can cover and is fixed to the corresponding tower body component 13. Such installation is simple, convenient and reliable.

In order to obtain a better ultrasonic energy efficiency ratio, each of the ultrasonic high-frequency vibration components 142 is an ultrasonic transducer of 1 MHz or above, or an ultrasonic vibration motor of 10,000 revolutions per minute or above.

For a neat appearance of the device, and to prevent the electric heating components 6, the ultrasonic high-frequency vibration components 142, etc. from being exposed to the outside, as shown in FIG. 1, this invention also comprises an outer casing 7 provided on the ultrasonic mixing tower 1. The outer casing 7 comprises a left half casing component 71 and a right half casing component 72 which are hinged together and close towards each other to accommodate the ultrasonic mixing tower 1 inside. Sleeve openings 73 are provided on the left half casing component 71 and the right half casing component 72 corresponding to the air input port 11 and the mixed gas output port 12. In order to prevent liquid from entering the outer casing 7 affecting electrical safety, as shown in FIG. 1, rubber sealing gaskets are also provided on the sleeve openings 73 respectively; hinge components are provided on corresponding first sides of the left half casing component 71 and the right half casing component 72 respectively, while lock components are provided on corresponding second sides of the left half casing component 71 and the right half casing component 72 respectively; the lock components lock the left half casing component 71 and the right half casing component 72 together. A rubber sealing gasket is also provided on a locking edge between the left half casing component 71 and the right half casing component 72 to ensure firm sealing of the two.

As shown in FIG. 1, an air heating mechanism 10 is provided. The air heating mechanism 10 has an air inlet 101 and an air outlet 102; the air inlet 101 is connected to an external air source, while the air outlet 102 is connected to the air input port 11. As shown in FIG. 1, the air heating mechanism 10 comprises a cylindrical casing 103 and an electric heating element covering the cylindrical casing 103. By preheating the input air, the moisture in the air is evaporated.

In addition, for better control of an output speed of the mixed gas, as shown in FIGS. 1-2, an electric fan 20 may also be connected to the mixed gas output port 12 to control gas flow.

In actual implementation, this invention generally comprises a junction box, where the electric circuit control board and operating keys, etc. are installed. The electric heating components 6, the ultrasonic high-frequency vibration components 142, the ultrasonic liquid atomizing mechanism 2 and the air heating mechanism 10, etc. are electrically connected to the electric circuit control board. Besides, a programmable MCU main control chip, as well as a Wi-Fi communication module or a Bluetooth® communication module may also be configured onto the circuit control board. Together with a corresponding application program written and installed on smart phones and tablet computers, etc., wireless communication and control will be achieved. This invention may be powered by alternating current or direct current to meet the actual needs in different occasions. A gas concentration measuring electrical components also provided on the mixed gas output port 12 of the ultrasonic mixing tower 1 to monitor the concentration of the mixed gas, thereby adjusting the air intake at the air input port or increasing the ultrasonic atomizing power of the ultrasonic liquid atomizing mechanism 2. As shown in FIG. 1, a pressure gauge 30 and an electromagnetic switch valve 40 are connected in series above the mixed gas output port 12 of the ultrasonic mixing tower 1 to facilitate the acquisition of air pressure data and the control of gas output.

What is claimed is:

1. An ultrasonic liquid-to-gas device with dynamic balance, comprising:
an ultrasonic mixing tower (1), wherein the ultrasonic mixing tower (1) is provided with an air input port (11) and a mixed gas output port (12), and is formed by a plurality of tower body components (13) connected together; each of the tower body components (13) is built-in with an ultrasonic hybrid cutting filter screen mechanism (14);
an ultrasonic liquid atomizing mechanism (2) is also provided inside the ultrasonic mixing tower (1) adjacent to the air input port (11); the ultrasonic liquid atomizing mechanism (2) atomizes liquid; atomized liquid generated by the ultrasonic liquid atomizing mechanism (2) is mixed with air input from the air input port (11);
a liquid supplying mechanism (3) is also provided in the ultrasonic liquid-to-gas device, wherein the liquid supplying mechanism (3) is connected with the ultrasonic liquid atomizing mechanism (2) through a pipeline to pump liquid to the ultrasonic liquid atomizing mechanism (2);
a dynamic self-balancing mechanism (4) is also provided in the ultrasonic liquid-to-gas device, wherein a middle position of the dynamic self-balancing mechanism (4) is tiltably connected to a bottom of the ultrasonic mixing tower (1), and four lateral sides of the dynamic self-balancing mechanism (4) are also tiltably connected to lateral sides of the ultrasonic mixing tower (1) respectively; the ultrasonic mixing tower (1) is balanced through the dynamic self-balancing mechanism (4).

2. The ultrasonic liquid-to-gas device of claim 1, wherein the dynamic self-balancing mechanism (4) comprises a base mounting seat (41), universal joints (42), an electric gyroscope (43) and a plurality of modifying and regulating motors (44); the base mounting seat (41) is connected with the bottom of the ultrasonic mixing tower (1) through one of the universal joints (42); the modifying and regulating motors (44) are connected with lateral sides of an upper surface of the base mounting seat (41) respectively, and are also connected with the lateral sides of the ultrasonic mixing tower (1) respectively through other corresponding universal joints (42) respectively; the electric gyroscope (43) is installed in the ultrasonic mixing tower (1).

3. The ultrasonic liquid-to-gas device of claim 2, wherein each of the modifying and regulating motors (44) comprises a vertical support (441), a horizontal push rod (442) and a motor (443); a bottom end of the vertical support (441) is connected to the base mounting seat (41); the motor (443) is installed on a top end of the vertical support (441); one end of the horizontal push rod (442) is connected to the motor (443), and another end of the horizontal push rod (442) is connected to a corresponding universal joint (42).

4. The ultrasonic liquid-to-gas device of claim 1, wherein the ultrasonic liquid atomizing mechanism (2) comprises a conical atomizing disk (21) and an ultrasonic atomizer module (22); the conical atomizing disk (21) is provided at a position in the ultrasonic mixing tower (1) facing the air input port (11), and the ultrasonic atomizer module (22) is installed at a bottom of the conical atomizing disk (21); a plurality of air spray nozzles (23) are distributed on an annular surface of the conical atomizing disk (21), and each air spray nozzle (23) is in communication with the air input port (11).

5. The ultrasonic liquid-to-gas device of claim 1, wherein each ultrasonic hybrid cutting filter screen mechanism (14) comprises a filter screen component (141) and an ultrasonic high-frequency vibration component (142) provided on the filter screen component (141).

6. The ultrasonic liquid-to-gas device of claim 1, wherein ultrasonic mechanisms (5) are provided on an outer lateral wall of each of the tower body components (13).

7. The ultrasonic liquid-to-gas device of claim 6, wherein each of the ultrasonic mechanisms (5) comprises an ultrasonic high-frequency vibrating component (142), a component casing (51), an elastic pressing component (52), and a connecting seat (53).

8. The ultrasonic liquid-to-gas device of claim 7, wherein each of the ultrasonic high-frequency vibration components (142) is an ultrasonic transducer of 1 MHz or above, or an ultrasonic vibration motor of 10,000 revolutions per minute or above.

9. The ultrasonic liquid-to-gas device of claim 1, wherein an outer casing (7) is provided on the ultrasonic mixing tower (1); the outer casing (7) comprises a left half casing component (71) and a right half casing component (72) which are hinged together and close towards each other to accommodate the ultrasonic mixing tower (1) inside; sleeve openings (73) are provided on the left half casing component (71) and the right half casing component (72) corresponding to the air input port (11) and the mixed gas output port (12).
